(19) United States
(12) Patent Application Publication
(10) Pub. No.: US 2015/0079554 A1
(43) Pub. Date: Mar. 19, 2015

(54) LANGUAGE LEARNING SYSTEM AND LEARNING METHOD

(71) Applicant: POSTECH ACADEMY-INDUSTRY FOUNDATION, Pohang-si (KR)

(72) Inventors: Gary Geunbae Lee, Pohang-si (KR); Hyungjong Noh, Incheon (KR); Kyusong Lee, Seoul (KR)

(21) Appl. No.: 14/396,763

(22) PCT Filed: Jan. 3, 2013
(86) PCT No.: PCT/KR2013/000004

§ 371 Date: Oct. 24, 2014

(30) Foreign Application Priority Data
May 17, 2012 (KR) 10-2012-0052646

(51) Int. Cl. G09B 5/04; G09B 19/06; H04L 29/08

(52) U.S. Cl. CPC G09B 5/04; H04L 67/10; G09B 19/06
USPC 434/157

(57) ABSTRACT

Disclosed herein are a language learning system and a language learning method. A language learning system includes a user terminal configured to receive utterance information of a user as a speech or text type and to output learning data transferred through a network to the user as the speech or text type, and a main server which includes a learning processing unit configured to analyze a meaning of the utterance information of the user, to generate at least one response utterance candidate corresponding to dialogue learning in a predetermined domain to induce a correct answer of the user, and to connect a dialogue depending on the domain and a storage unit linked with the learning processing unit and configured to store material data or a dialogue model depending on the dialogue learning.

### TECHNICAL FIELD

The present invention relates to a language learning system and a language learning method, and more particularly, to a learning system and a learning method using a response generation method of learning a language based on natural language processing.

### BACKGROUND ART

With the increase in necessity of foreign language education, many schools invite native speaker teachers to better teach a foreign language. However, since time is restricted and a class system is configured of one teacher with many students, students have a limited opportunity to speak with the native speaker teacher and thus it is actually inefficient in terms of academic achievement.

Further, in a school located in a remote area where hiring a native speaker teacher is difficult or a place where an infrastructure of foreign language education is not constructed, it is very difficult to efficiently learn a foreign language through a systematic curriculum.

An education method and an education system easily accessing and learning foreign language learning contents anywhere and any time through the Internet which is rapidly developing to overcome the limitation of the foreign language education method are increasingly progressed.

However, in the case of the foreign language learning method using the Internet, students may not directly communicate with a native speaker or a foreign language teacher as in offline learning and therefore it is difficult to immediately perform customized education or pronunciation correction of a foreign language, and for students who learn a foreign language by themselves under their own initiative, it is difficult to be motivated to learn as compared to the offline learning because interest is decreased or continuous learning is not consistently performed.

Therefore, a study on an education system and an education method to expect a learning effect even in the foreign language education through the Internet compared with actually attending a class by a native speaker or a foreign language teacher offline is required.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a learning system and a learning method having advantages of generating a most appropriate response using natural language processing during language learning. That is, when a learner does not know what to respond while learning, learner utterance is induced using response generation to help continue conversation, and motivation and interest may be generated using problem generation.

Therefore, a foreign language education system and a foreign language education method developed as an online program may expect a learning effect compared with actually attending a class taught by a native speaker or a foreign language teacher offline are provided.

The technical objects to be achieved by the present invention are not limited to the above-mentioned technical objects. That is, other technical objects that are not mentioned may be obviously understood by those skilled in the art to which the present invention pertains from the following description.

### Technical Solution

An exemplary embodiment of the present invention provides a language learning system, includes a user terminal configured to receive utterance information of a user as a speech or text type and to outputlearning data transferred through a network to the user as the speech or text type; and a main server which includes a learning processing unit configured to analyze a meaning of the utterance information of the user, to generate at least one response utterance candidate corresponding to dialogue learning in a predetermined domain to induce a correct answer of the user, and to connect a dialogue depending on the domain and a storage unit linked with the learning processing unit and configured to store material data or a dialogue model depending on the dialogue learning.

Another exemplary embodiment of the present invention provides a language learning method, including: accessing a main server for language learning to input utterance information for dialogue learning under a predetermined domain; analyzing a meaning of the utterance information of a user and determining whether the analyzed utterance information is utterance content corresponding to the domain to manage the dialogue learning; progressing following dialogue learning in the domain in the case of the utterance corresponding to the domain; and generating at least one response utterance candidate data corresponding to the dialogue learning under the domain in the case of the utterance which does not correspond to the domain or when there is a request of the user and inducing a response utterance of the user corresponding to the domain.

Yet another exemplary embodiment of the present invention provides a language learning method, including: accessing a main server for language learning to input utterance information for dialogue learning under a predetermined domain; analyzing a meaning of user utterance information and determining whether the analyzed utterance information is utterance content corresponding to the domain; progressing following dialogue learning in the domain in the case of a correct answer utterance corresponding to the domain; generating at least one response utterance candidate data to extract core words in the case of the utterance which does not correspond to the domain or when there is a request of the user and providing a first hint for a response utterance corresponding to the domain; inputting, by the user, first re-utterance information using the first hint and modeling generation of a grammar error using the at least one response utterance candidate data when the first re-utterance information is an utterance which does not correspond to the domain or there is the request of the user to provide a second hint due to the acquired grammar error; and inputting, by the user, second re-utterance information using the second hint and directly providing a correct answer utterance corresponding to the domain when the second re-utterance information is an utterance which does not correspond to the domain or there is the request of the user.

### Advantageous Effects

According to the language learning system and the language learning method according to the exemplary embodiments of the present invention, it is possible to improve the efficiency of learning the language due to the learning motivations, the induction of interest, and the continuous learning induction effect by providing a hint to the learner using the response generation method when learning the language online through use of the computer.

In detail, it is possible to increase the educational interest of the foreign language learning, which automatically tests the learner by using the generated expressions which match the currently given domain or generating the expressions which do not match the currently given domain, while the learner listens and repeats the foreign language by listening to what the learner says through the speech synthesis module.

Therefore, even when the learner who performs learning by herself or himself under his/her own initiative online using the language education program does not know what the utterance by the learner is, the high-quality foreign language learning system and method for increasing the interest of learning and inducing the effect comparable with actually attending a class taught by the foreign teacher or the native speaker may be provided.

### DESCRIPTION OF THE DRAWINGS

FIG. 1 is a block diagram of a language learning system according to an exemplary embodiment of the present invention.

FIG. 2 is a block diagram of an utterance candidate generation unit of a main server in the language learning system of FIG. 1.

FIG. 3 is an exemplified diagram of a dialogue example calculation module using a response utterance generated from the utterance candidate generation unit of FIG. 2.

FIG. 4 is a flowchart illustrating a language learning method according to an exemplary embodiment of the present invention.

FIG. 5 is a flowchart illustrating an example of a step of generating a core word in the language learning method of FIG. 4.

FIG. 6 is a flowchart illustrating a language learning method according to another exemplary embodiment of the present invention.

FIGS. 7 and 8 are diagrams illustrating an example of generation of a grammar error in the language learning system and the language learning method according to the exemplary embodiment of the present invention.

FIG. 9 is a flowchart illustrating a step of generating a grammar error of FIGS. 7 and 8 in the language learning method of FIG. 4.

FIG. 10 is a diagram illustrating an exemplified screen of an answer of an example of choosing types for uttering a problem and an appropriate response sentence in a given domain according to the language learning system and method according to the exemplary embodiment of the present invention.

FIG. 11 is a diagram illustrating a response generation through an extraction of a core word and generation of a grammar error according to the language learning system and method according to the exemplary embodiment of the present invention.

### MODE FOR INVENTION

The present invention is to provide a learning system and a learning method having advantages of generating a most appropriate response using natural language processing during language learning. That is, when a learner does not know what to respond while learning, learner utterance is induced using response generation to help continue a conversation, and motivation and interest in learning may be generated using problem generation.

Therefore, a foreign language education system and a foreign language education method developed online to expect a learning effect compared with actually attending a class taught by a native speaker or a foreign language teacher offline are provided.

The technical objects to be achieved by the present invention are not limited to the above-mentioned technical objects. That is, other technical objects that are not mentioned may be obviously understood by those skilled in the art to which the present invention pertains from the following description.

Hereinafter, the present invention will be described more fully with reference to the accompanying drawings, in which exemplary embodiments of the invention are shown. As those skilled in the art would realize, the described embodiments may be modified in various different ways, all without departing from the spirit or scope of the present invention.

Further, in exemplary embodiments, since like reference numerals designate like elements having the same configuration, a first exemplary embodiment is representatively described, and in other exemplary embodiments, only different configurations from the first exemplary embodiment will be described.

In order to clearly describe the present invention, portions that are not connected with the description will be omitted. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

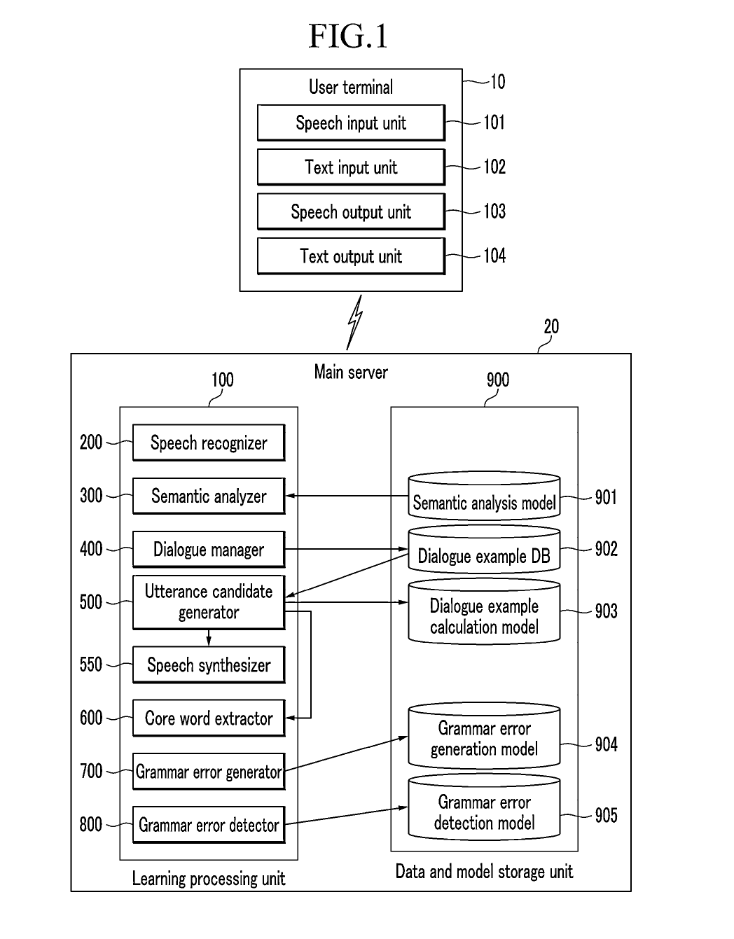

FIG. 1 is a block diagram of a language learning system according to an exemplary embodiment of the present invention.

Referring to FIG. 1, a language learning system according to an exemplary embodiment of the present invention is configured to largely include a user terminal 10 and a main server 20 for language learning which is connected to the user terminal through a network. A detailed configuration means of the user terminal 10 and the main server 20 to be described below is exemplified and therefore is not necessarily limited to the configuration of FIG. 1, and the configuration may be changed by adding or omitting a means which may perform a function of the language learning method of the present invention.

In FIG. 1, the user terminal 10 is configured to include a speech input unit 101, a text input unit 102, a speech output unit 103, and a text output unit 104.

When a user (learner) conducts an utterance, the speech input unit 101 is a means of receiving speech, and when the user transfers dialogue content as text instead of the utterance, the text input unit 102 is a means of receiving text information. Dialogue data of foreign language learning input as the speech or the text are transmitted to the main server 20 through network communication. Result value data of the main server 20 side are transmitted to the user terminal 10 through the network communication and output from the speech output unit 103 or the text output unit 104 of the user terminal.

The speech output unit 103 is a means of outputting a result value of a response dialogue according to the foreign language learning of the main server 20 as speech data, and the text output unit 104 is a means of outputting the result value of the response dialogue as the text.

In FIG. 1, the user terminal 10 is exemplified as one terminal, but the user terminal connected to the main server 20 to transmit and receive data through the network communication may be configured in plural.

In FIG. 1, the main server 20 may be configured to include a learning processing unit 100 and a data and model storage unit 900.

The learning processing unit 100 is a means of processing data by a foreign language learning method according to the exemplary embodiment of the present invention.

The data and model storage unit 900 stores a dialogue corpus (language material) or models of foreign language dialogue data which are transferred to the learning processing unit, or material data or dialogue models which are obtained by performing the learning processing.

The learning processing unit 100 may be configured to include a speech recognizer 200, a semantic analyzer 300, a dialogue manager 400, an utterance candidate generator 500, a response generator 550, a core word extractor 600, a grammar error generator 700, and a grammar error detector 800.

The data and model storage unit 900 includes a plurality of data bases which are specifically divided into a semantic analysis model 901, a dialogue example DB 902, a dialogue example calculation module 903, a grammar error generation model 904, and a grammar error detection model 905, and stores dialogue corpus data required in the language learning system according to the exemplary embodiment of the present invention, a machine learning model generated by being extracted from the dialogue corpus data, result data depending on learning processing, or the like.

The semantic analysis model 901 stores a semantic analysis model for analyzing a sentence and result values analyzing a sentence meaning of the dialogue corpus data depending on the semantic analysis model.

The dialogue example DB 902 extracts and stores dialogue examples configured of a series of dialogue sentences associated with a corresponding domain from the dialogue corpus data.

The dialogue example calculation model 903 stores a calculation module used to designate an appropriate response candidate of the user for the corresponding domain, and again stores the response utterance candidates selected depending on the calculation model as a result value.

The grammar error generation model 904 models a grammar error for an appropriate response sentence among a plurality of response utterance candidate groups, and stores a grammar error response candidate sentence with a grammar error word selected depending on a probability value.

The grammar error detection model 905 stores the grammar error data again detected from contents which are corrected and answered by the user (learner). The modeling is performed using the redetected grammar error data to be able to derive a detection pattern of the grammar error depending on the re-learner utterance.

The speech recognizer 200 of the learning processing unit 100 receives the speech data input by user utterance in the user terminal 10 through the network communication to recognize the speech data and change the speech data to text data corresponding to the speech data. The changed text data is transferred to the semantic analyzer 300 to extract a semantic content of the sentence or the dialogue. In this case, when the learner (user) performing the foreign language learning inputs dialogue content of a foreign language class as the text data, not as the speech data, through the text input unit 102 of the user terminal 10, the corresponding text data are directly transferred to the semantic analyzer 300 without passing through the speech recognizer 200.

The semantic analyzer 300 extracts the meaning of the foreign language sentence of the user which is transferred as the text data. Although described below, it is determined whether the sentence input by the user is an appropriate response depending on the corresponding domain based on the analyzed meaning during the language learning process of the learning system.

The semantic analysis method may be various, but as the exemplary embodiment of the present invention, the semantic analyzer 300 extracts material or information stored in the semantic analysis model 901 of the data and model storage unit 900 and analyzes a meaning using a machine learning method such as CRF and MaxEnt using the extracted material or information.

For example, in English learning, for the user to conduct a dialogue using English under the given way-finding domain, when data such as “Do you know how to get to Happy Market?” is input as a speech or text type, the semantic analyzer 300 may analyze as a type such as (speech act: Ask, head act: search_location, entity name: <location>Happy Market</location>) as a result value of the semantic analysis. A result obtained by analyzing one sentence by the modeling method of the speech act, the head act, and the entity name may be considered as one node.

The above example is based on the semantic analysis type and the analysis method of the sentence stored in the semantic analysis model 901, and is not necessarily limited to the modeling method of the speech act, the head act, and the entity name. The corpus of a large-capacity dialogue sentence may be modeled in various semantic analysis types depending on a set type, and may be stored in the semantic analysis model 901 by being divided depending on the modeling type of the predetermined semantic analysis.

In the semantic modeling analysis type according to the exemplary embodiment of the present invention, the speech act is an element which may generally and independently define a grammatical structure or characteristics of a sentence. That is, the speech act means an element which defines and classifies the sentence structure as normal, demand, ask, Wh-question, not, and the like. In the example of the way finding domain, the sentence “Do you know how to get to Happy Market?” is the ask and therefore the speech act element is defined as the ask.

The head act is an element which is represented by a representative word which may analyze the meaning of the sentence to specifically define features of the sentence content. That is, the sentence content “Do you know how to get to Happy Market?” means a position of a market, and therefore the head act element may be defined as search_{—market.}

Further, the entity name is a unique mark which classifies most detailed and special characteristic content components from the sentence content, and may be set as a proper noun of, for example, a place, an object, a person, and the like. The most detailed and characteristic entity in the sentence content “Do you know how to get to Happy Market?” is Happy Market and therefore the entity name for the sentence may be defined as market_Happy Market.

According to the exemplary embodiment of the present invention, the semantic analysis model of the dialogue corpus for the language learning system may analyze and store the entire sentence as a node of speech act_head act_entity name as described above.

The dialogue manager 400 receives the input text data of the user (in the above example, “Do you know how to get to Happy Market?”) and modeling values (in the above example, speech act, head act, entity name) which are analyzed by the semantic analyzer 300 to determine a response (or action) at the language learning system side. That is, it is determined how to process an answer or a response in response to the dialogue content (in the above example, a sentence of a question form) of the user (learner).

In the case of the question of the above example, for a question asking a position of the Happy Market, the dialogue manager 400 determines the countermeasure (or action) direction to the question whether to give an answer as a case of knowing the position or an answer as a case of not knowing the position.

Further, the dialogue manager 400 determines whether the utterance contents of the speech data or the text data input by the user are appropriate utterance contents corresponding to a domain set in a language education program.

That is, it is determined whether the utterance content of the user is appropriate for the domain in the education program, and if appropriate, the subsequent utterance is continuously presented on the system. When an appropriate response is uttered, the utterance sentence of the user may be stored in the dialogue example DB 902 of the data and model storage unit 900.

Further, when the user response utterance is inappropriate, the dialogue manager 400 directly provides a correct answer to the user or generates the response utterance candidate for user learning to perform management to allow the learner to search for an appropriate sentence by himself/herself.

In this case, the dialogue manager 400 selects one of the appropriate response utterance candidate groups of the dialogue content generated from the dialogue candidate generator 500, without being limited to the method of directly providing the correct answer to present the selected response utterance candidate group to the user in an example of choosing problem type along with an inappropriate response.

The utterance candidate generator 500 generates the corresponding response candidates depending on the countermeasure direction of the dialogue content determined by the dialogue manager 400. The response candidates points out the utterance sentences which may be appropriate responses as a dialogue of the user under the corresponding domain during the connection process of the dialogue for language learning between the learning system and the user. The response candidates are transferred to the user terminal 10 and thus may be the utterance candidate groups which are output to the user.

In detail, the utterance candidate generator 500 generates a plurality of sentences as response candidates in the action direction determined depending on the dialogue content transferred from the user terminal.

The utterance candidate generator 500 extracts the plurality of response candidate groups to be transmitted to the user terminal from the dialogue example DB 902 of the data and model storage unit 900.

In this case, many dialogue examples stored in the dialogue example DB 902 extract feature components from numerous corpus materials using a machine learning method to generate a feature vector, and are acquired using a machine learning information pool accumulated by predicting feature components for new input information.

The machine learning means an input and storage process of information for constructing a material source which is a base so as to be used at the time of processing information using a computer or providing application.

According to the present invention, the machine learning information pool for providing the language learning system using the computer is configured of feature vectors in which feature components are gathered in a predetermined amount.

Here, the feature component means an individual characteristic or feature of information which is a collection reference at the time of performing the machine learning. For example, the feature component is a component such as a height, a head length, and the like of a person which may be acquired from the scan information.

The feature vector gathers a plurality of feature components and values of actual materials corresponding thereto, at a level to predict the feature components from the new input information.

In the example, the information group in which the values (height=180, head length=10 cm) depending on the feature components acquired for each input information based on the feature components of a person such as a key and a head length are collected in thousands of units and tens of thousands of units becomes the feature vector.

The machine learning information pool is configured of the feature vectors, and dialogue examples may be generated under various domains by using the machine learning information pool.

In the example, when, for the question of the position of the Happy Market of the user, the dialogue manager 400 determines the action direction as knowing the position, the utterance candidate generator 500 may generate a plurality of sentences informing the position as the response (utterance) candidate group.

Here, the utterance candidate generator 500 may use the dialogue content depending on the domain to acquire the feature components in the previous dialogue and the current dialogue by the machine learning method, and may use the acquired feature components as the feature vectors.

Both of the utterance candidate having the highest prediction result order and the utterance candidate corresponding to the predetermined order among the predicted sentences extracted from the dialogue example DB 902 using the feature vectors are extracted, which may be designated as the response candidates.

In other words, the utterance candidate generator 500 may extract the responsible dialogue example information from the dialogue example DB 902 depending on the countermeasure determination of the dialogue determined by the dialogue manager 400, based on the feature vectors by the machine learning method. The dialogue example calculation model 903 may be used to designate the response candidate corresponding to the sentence of the user by using the dialogue example information. Further, the selected response candidates may be again stored as the result values of the dialogue example calculation model 903.

The speech synthesizer 550 synthesizes the speech by combining the utterance candidate result values generated from the utterance candidate generator 500 with the pre-registered utterance information, and outputs the synthesized speech to the user terminal.

That is, in order to induce the repeat learning and the utterance practice of the user (learner), The speech synthesizer 550 combines the sentences included in the utterance candidate groups or the correct answer sentences with the pre-registered sentences (eg., “You can say something like”, “repeat after me”, and the like) and synthesizes the combined sentences with speech and output the synthesized speech to the user terminal.

Meanwhile, the induction problem is output to the user terminal 10 for the user to infer a correct answer using the core word extractor 600 and the grammar error generator 700 based on the generated utterance candidate group. The core word extractor 600, the grammar error generator 700, and the grammar error detector 800 may be defined as the response inducer which helps the user to derive a correct answer.

The core word extractor 600 may extract the common core words from the utterance candidate groups generated by the utterance candidate generator 500 and present the problem of inferring the response to the user utterance based on the extracted core words.

That is, the core word extractor 600 does not directly present a correct answer sentence among the response candidate of the utterance candidate generator, but extracts the core words from the response candidate groups to generate the problem of inducing the user to perform an appropriate response and present the generated problem.

The grammar error generator 700 models the grammar errors for the appropriate response sentences of the utterance candidate groups generated by the utterance candidate generator 500, and presents the response candidates with the grammar errors. That is, the response candidate with the grammar error is presented as a quiz type to allow the learner to correct the error by himself/herself so as to search for an appropriate correct answer to the dialogue.

The sentence of the response candidate groups with the grammar error generated by the grammar error generator 700 may be stored in the grammar error generation model 904. Further, the sentence examples with the grammar error are stored and accumulated in the grammar error generation model 904 by the method, and thus may be continuously used in the language learning.

The method for generating the grammar error for the example sentences of the utterance candidate groups by the grammar error generator 700 is not particularly limited, but the machine learning method such as MaxEnt and CRF may be used.

Further, the grammar error detector 800 detects whether the grammar error is still present in the answered sentence by allowing the learner to correct the utterance candidate with the grammar quiz or the grammar error presented by the grammar error generator 700.

The grammar error detector 800 again stores the grammar error data detected from the content that is corrected and answered by the learner in the grammar error detection model 905, and uses the grammar error data to perform the modeling and set the detection pattern of the grammar error due to the re-utterance of the learner.

Meanwhile, the grammar error detector 800 is not used in the learning process of performing the user utterance by presenting the grammar error problem, and may detect the grammar error for the response re-uttered by the user through the core word extractor 600 or the utterance of the user transferred to the dialogue manager 400.

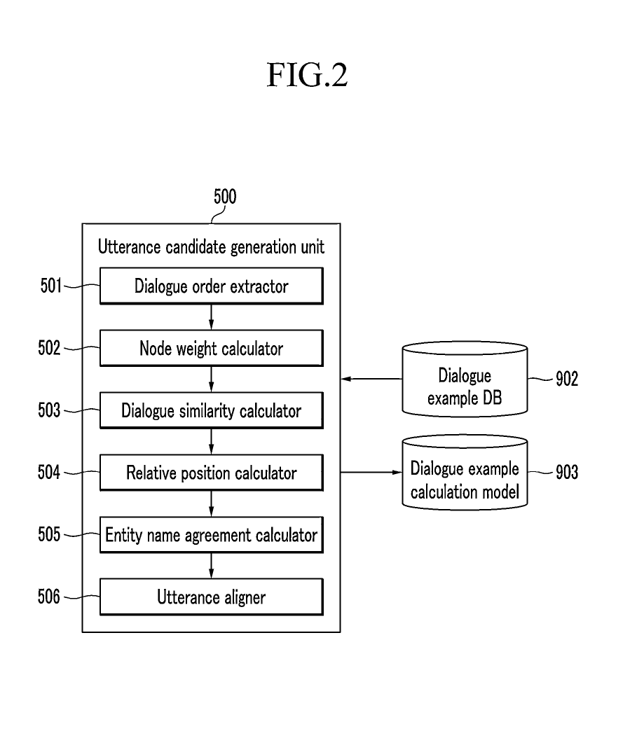

FIG. 2 is a block diagram of an utterance candidate generator 500 of the main server 20 in the language learning system of FIG. 1.

The utterance candidate generator 500 is linked with the dialogue example DB 902 and the dialogue example calculation model 903 of the data and model storage unit 900 to exchange information and store generated result information. That is, the utterance candidate generator 500 generates the dialogue example calculation module 903 based on the dialogue example DB 902.

In detail, the utterance candidate generator 500 may be configured to include a dialogue order extractor 501, a node weight calculator 502, a dialogue similarity calculator 503, a relative position calculator 504, an entity name agreement calculator 505, and an utterance aligner 506, but is not necessarily limited to the exemplary embodiment.

A method for generating a dialogue example calculation module using the components in the utterance candidate generator 500 is as follows.

The dialogue order extractor 501 extracts an order of all dialogues associated with the corresponding domains given at the time of learning the foreign language from the sentence information stored in the dialogue example DB 902.

A plurality of pieces of dialogue information may be extracted based on a modeling method stored in the semantic analysis model 901.

For example, the dialogue example DB 902 may store a dialogue example corpus in which the speech act, the head act, and the entity name are tagged.

Here, a form of ([object]_[speech act]_[head act]_[entity name]) may be set as one node N. The [object] may be a server side of the language learning system corresponding to the server 20 or a user (learner) side corresponding to the user terminal 10.

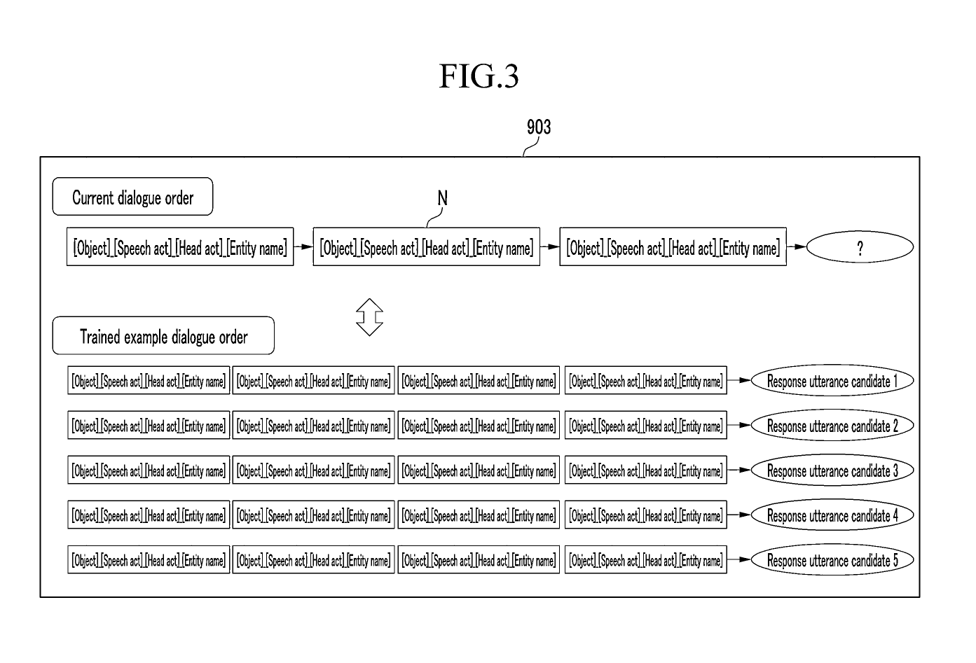

Each dialogue sentence is classified into a form such as the node, and the dialogue order may be aligned and stored as illustrated in FIG. 3. FIG. 3 exemplifies the dialogue example calculation module using the response utterance generated from the utterance candidate generator 500.

As illustrated in FIG. 3, a plurality of trained example dialogue orders may be aligned in plural in correspondence with a current dialogue order for a learner to conduct language learning depending on a current domain.

The node weight calculator 502 generates the dialogue example calculation model 903 aligned as illustrated in FIG. 3, and calculates node weight using the generated dialogue example calculation model 903.

The node weight may set the weight for each node N of FIG. 3 as a relative value, and sentence (node) data extracted from the corpus which is a material source may be calculated in advance.

The node weight is used when the dialogue similarity calculator 503 calculates similarity between the current dialogue order and the trained example dialogue.

According to the exemplary embodiment, the dialogue similarity calculator 503 may use a Levenshtein distance method as a method for calculating similarity.

The method for calculating the node weight in the node weight calculator 502 is not particularly limited.

Here, the node weight relates to a relative weight value of a node10 in the relationship between a previous node (referred to as node1) and a next node (referred to as node100) of the corresponding node (referred to as node10) during progress of dialogue. That is, the number of node100 next to the node10 may be written by a term called perplexity, and it may be considered that the lower the perplexity, the higher the weight of the node10 in the dialogue progressed from node1 toward the node100 via the node10.

Next, referring to Table 1, it is shown that when the node10 is a request/path (for example, “How can I get to Happy Market?”), the node1 is two nodes of ask/help and ask and the node 100 is two nodes of instruct/path and ask/know_landmark.

Further, it is shown that when the node10 is a node called feekback/positive (for example, “Yes”), the node1 is four nodes of check-q/location, offer/help_find_place, yn-q/know_landmark, and yn-q/understand, and the node100 is three nodes of yn-q/can_find_place, instruct/path, and Express/great.

Therefore, since when the node10 which is the corresponding node is set as a reference, the perplexity of request/path is 2 and the perplexity of feekback/positive is 3, the node weight of the case of request/path may be set to be higher than that of the case of feekback/positive.

TABLE 1

| node1 | node10 | node100 |
|---|---|---|
| ask/help | request/path | instruct/path |
| as | (How can I get to Happy | ask/know_landmark |
| | Market?) | |
| check-q/location | feekback/positive | yn-q/can_find_place |
| offer/help_find_place | (Yes.) | instruct/path |
| yn-q/know_landmark | | Express/great |
| yn-q/understand | | |

In other words, when there are many cases going from a first node of the trained example dialogue data to a second node, the weight of the corresponding first node is reduced. To the contrary, when the number of nodes at which the first node may arrive is few, the weight of the first node is increased.

By the method, the node weight calculator 502 previously calculates relative values of weights for each node of the current dialogue order based on the corpus data. The node weight is a previously calculated value and therefore is not changed during the execution of the language learning system.

The dialogue similarity calculator 503 calculates similarity between one of a plurality of nodes included in the current dialogue and one of a plurality of nodes included in the trained example dialogue order by using the Levenshtein distance calculation method. A method for determining similarity between nodes may be various, and is not necessarily limited to the Levenshtein distance calculation method.

The Levenshtein distance calculation method is a method for converting and obtaining the similarity between the respective nodes into a similarity distance concept to which the node weight is reflected.

In detail, when in the current dialogue order, the node to be compared is the same as a dialogue node on the corpus included in the trained example dialogue order, the weight is subtracted by as much as the weight of the node, when a new node is added (inserted) and is deleted, the weight is added by as much as the weight of the corresponding node, and when the node is replaced by another node, the weights of the two nodes are summed and are divided by 2. By the method, the similarity may be objectively calculated based on the node weight between the current dialogue node and the trained example dialogue node.

Many dialogues are included in the corpus data, and the Levenshtein distances for each node order which is progressed in the current dialogue may be calculated based on these corpus data.

Table

Table 2 shows the current dialogue and partially selected dialogue cases on the corpus to describe a similarity determination process. A parenthesis indicates a node weight value.

Table

Referring to an example presented in Table 2, when a distance from dialogue case 1 on the corpus is calculated, since START and mar/exe are the same as the current dialogue, no value may be added to the weight. However, a node of a next discourse history is ask_help during the current dialogue progress, and since the case 1 is inf_mul, an average value of weights of the corresponding two nodes is added to a total value of a similarity distance between two nodes. By the method, the similarity distance for dialogue cases 2 and 3 on the remaining corpus is calculated while the similarity distance between the corresponding nodes between two dialogues is calculated. When the calculation for the dialogues on the corpus is completed, if it is assumed that in the case 1, the distance between the current dialogue and the node is smallest, an appropriate node at a current time in the current dialogue becomes stat/nor of the case 1.

TABLE 2

| | | | | | | |
|---|---|---|---|---|---|---|
| Current | START | mar/exe | ask_help | req/loc | con/des | Current |
| Dialogue | | 0.1 | 0.234 | 0.343 | 0.53 | Time |
| Discourse | | | | | | |
| history | | | | | | |
| Dialogue | START | mar/exe | Inf_mul | ask/fav | con/des | Stat/nor |
| On | | 0.1 | 0.4 | 0.4 | 0.53 | 0.4 |
| Corpus | | | | | | |
| case1 | | | | | | |
| Dialogue | START | inf/pos | ask_help | req/loc | ask/fav | stat/ask |
| On | | 0.4 | 0.234 | 0.343 | 0.4 | 0.5 |
| Corpus | | | | | | |
| case2 | | | | | | |
| Dialogue | START | . . . | . . . | . . . | . . . | . . . |
| On | | | | | | |
| Corpus | | | | | | |
| case3 | | | | | | |

The dialogue similarity calculator 503 calculates similarities for all the dialogues using the node weight, and the example dialogue corpus may be aligned in the low order or the high order of the calculated similarity result value.

The relative position calculator 504 calculates the relationship between he respective nodes, that is, the relative position between the nodes based on an order of the dialogue information stored in the dialogue example DB 902.

Here, the relative position between the nodes means a relatively appearing weight value between the nodes based on the probability value that the predetermined node appears and then another node appears.

That is, when a node called certain A on the example corpus appears only after a node called B appears, a node called B in a real dialogue does not appear and a probability that a node called A appears may be low.

In the case 1 on the corpus of Table 2, ask/fav appears after a mar/exe node, and when the ask/fav is applied to the dialogue on all the corpuses, the mar/exe node is disclosed in the current dialogue and therefore the appearance of the ask/fav at the current time may be appropriate. However, when the mar/exe node is not present in the current dialogue, the probability that the ask/fav appears at the current time is low.

Therefore, the relative position calculator 504 calculates the appearance probability between the nodes based on the node order of the dialogue cases included in the corpus data to calculate the relative position between the nodes.

The entity name agreement calculator 505 calculates the probability that the entity name which agrees with the entity name of the node included in the current dialogue order for each node included in the trained example dialogue data of FIG. 3 appears.

An example of the method for calculating agreement of the entity name will be described based on the given question of the current dialogue in a way-finding domain in the language learning.

That is, when the entity names of each node belonging to the example dialogue corpus are classified into detailed entity name vectors such as [location, loc_type, time, distance, landmark], the corresponding probability value of each entity name vector is calculated from the previously collected dialogue corpus. When the entity name appears as [0.0, 0.0, 0.0, 0.0, 0.0] in an (Express_greeting) domain, it means that no same entity name appears in an Express_greeting domain once. Meanwhile, when the entity name appears as [0.3, 0.5, 0.0, 0.0, 0.0] in the ask_distance domain, it means that the probability that a unique location entity name appears is 30% in all the data from which the (ask_distance) domain appears in the dialogue example DB, and it means that the probability that a unique loc_type entity name appears is 50%.

The entity name vector is generated based on the entity name appearing in each dialogue example (for example, [1, 1, 0000], location, and loc_type appear up to now), and a score of the trained entity name vector using the entity name vector and the dialogue example DB is calculated based on cosine similarity. The higher the score, the higher the agreement of the entity name.

Here, the corresponding entity names such as location and loc_type are differently set by each developer depending on the domain. For example, in the case of a market domain, the entity name vector may be set as [Food_name, food_type, price, market_name].

The generation of the entity name vector and the calculation of the entity name agreement are used to search for the most appropriate response.

The utterance aligner 506 aligns the response utterance candidates in consideration of all of the Levenshtein distances, the relative position between the nodes, and the entity name agreement which are the result values of the dialogue similarity calculator 503, the relative position calculator 504, the entity agreement calculator 505, and generates the response utterance data which are in the highest order as the result value of the utterance candidate generator 500 and determines the response utterance data having the lowest value as utterance information which is not possible. The user (learner) himself/herself may use appropriate response utterance data having a high order or inappropriate response utterance data having a low order all of which are generated from the utterance aligner 506 in a problem presented to utter the most appropriate response under the given domain.

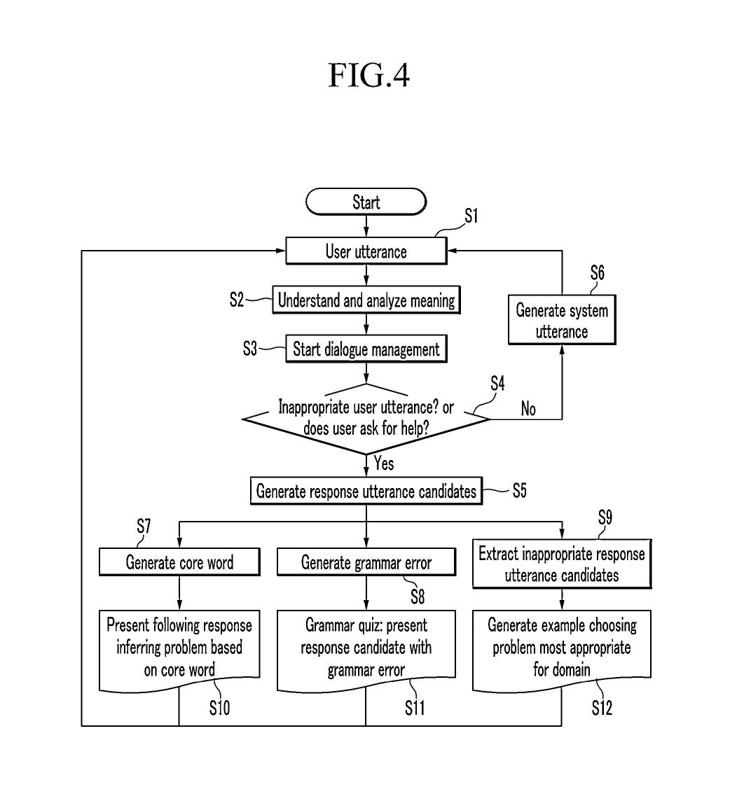

FIG. 4 is a flowchart illustrating a language learning method according to an exemplary embodiment of the present invention.

First, the learner (user) accesses a language learning system through the user terminal 10 to perform utterance depending on the given domain (or accessing the given domain) during a foreign language education process (S1). The start of the utterance may be first performed in the system or the learner may first start.

The speech information of the corresponding utterance may be converted into the text information or the corresponding utterance may be exceptionally input in a text information form.

The semantic understanding and analysis of the sentence are performed based on the text information corresponding to the utterance contents of the learner utterance for each domain (S2).

The meaning of the utterance contents is analyzed in a node unit by a preset modeling technique depending on the semantic analysis model.

Further, the meaning for each node is extracted and the dialogue management starts (S3).

As described above, it is determined whether the start of the dialogue management determines the response direction for the given domain and then the learner utterance is appropriate corresponding to the response direction. That is, when the dialogue management starts and then the response direction is determined, the appropriateness of the user utterance is determined and it is queried whether the user utterance is the inappropriate user utterance or the user asks for help (S4).

When it is determined that the user utterance is an appropriate sentence or the user does not ask for help, the utterance of the language system is generated depending on the subsequent continued appropriate dialogue and is transferred to the user (S6).

To the contrary, when it is determined whether the user utterance is not appropriate or the user asks for help, the response utterance candidate data depending on the domain are generated (S5). That is, the appropriate utterance data depending on the domain are extracted or generated by executing the utterance candidate generator. In this case, the response utterance candidate data depending on the domain may be aligned in sequence depending on the probability order on the basis of the appropriateness and weight of the domain.

Core words for the aligned response utterance data (result values) may be generated (S7), the grammar error may be generated (S8), or the inappropriate response utterance candidates may be extracted (S9). Further, although not illustrated in FIG. 4, a correct answer may be directly provided to the user by the user request.

Processes S7 to S9 are various methods which use the response utterance candidate data to induce an interest of a learner so as to provide an opportunity to correct to an appropriate utterance depending on the domain. Therefore, the language learning system and method according to the exemplary embodiment of the present invention does not limit the processes of correcting the user utterance thereto, and therefore may be variously provided.

The process of S7 of generating the core word extracts and stores core words from the response utterance candidate data and then presents a problem of inferring the appropriate response depending on the corresponding domain to the user based on the core words (S10). Next, the learner (user) uses the presented core word to search for the appropriate utterance depending on the corresponding domain by himself/herself.

Meanwhile, when using the process S8 of generating the grammar error, the grammar error which is probably made is set for the data selected from the response utterance candidates and the response candidate with the grammar error is presented to the user (S11).

Next, the learner (user) solves a quiz presented by the response utterance candidate data with the grammar error to search for the appropriate utterance depending on the domain while correcting the corresponding grammar error.

Further, when applying the process S9 of extracting the inappropriate response utterance candidates, the looking and choosing problem depending on the domain may be generated using the response utterance candidate result value generated in S5 and presented to the user (S12). The looking and choosing problem presents the response utterance candidate corresponding to the correct answer and the inappropriate response utterance candidates as the plurality of examples.

Next, the learner (user) himself/herself may search for the appropriate utterance content depending on the domain using the looking and choosing problem.

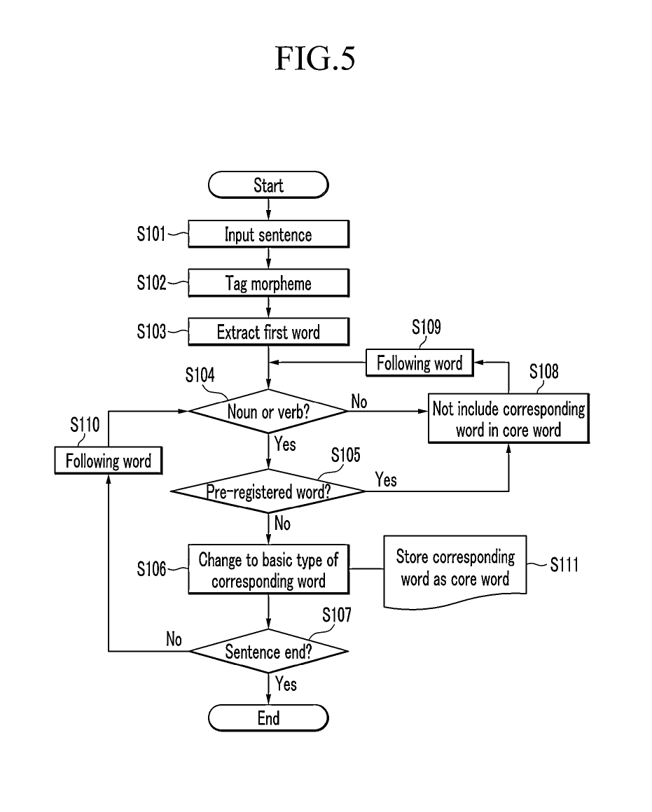

FIG. 5 is a flowchart illustrating an example of a step of generating a core word in the language learning method for FIG. 4.

First, the input sentence is extracted or acquired (S101). In the learning process of FIG. 4, the input sentence may be selected from the plurality of response utterance candidate data.

The input sentence is tagged in a morpheme form (S102). The morpheme means a minimum unit having a unique meaning, and is attached with a tag in a minimum semantic unit to search for the core word.

Next, the word is sequentially extracted from a first word of the input sentence (S103). It is confirmed whether the corresponding word is a noun or a verb by sequentially extracting the word from the first word of the input sentence (S104). When the corresponding word is neither of a noun or a verb, the corresponding word is not included in the core word (S108) and the next word is confirmed depending on the arrangement order of the word of the sentence (S109). When the corresponding word is a noun or a verb, it is confirmed whether the corresponding word is the pre-registered word as the core word (S105).

When the corresponding word is the pre-registered core word, the corresponding word is also not included in the core word (S108). Further, the learning enters a process of confirming whether a next word of the sentence is a noun or a verb (S109).

In step S105, when the corresponding word is not the pre-registered core word, the corresponding word is changed to a basic form of the corresponding word (S106). For example, a basic form of liked and likes is like, and a basic form of easier is changed to a basic form by the same manner as easy.

The corresponding word changed to the basic form is stored as the core word (S111).

Next, after it is queried whether the corresponding word is a final word of the input sentence (S107), if it is determined that the corresponding word is the final word of the sentence, the process ends, and otherwise processes below the step S104 are repeated for the next word (S110) of the input sentence. The processes below the step S104 are sequentially repeated for the final word of the input sentence. In step S111, the stored core words are used in the inferring problem to enable the learner to infer the appropriate response utterance in the step S10 of FIG. 4.

For example, as the core words for inferring the appropriate response utterance simultaneously with presenting a dialogue such as “Where are you going?” as a question form in the learning system, go, which is a verb, and market, which is a noun, may be presented.

Next, the user may infer the optimal response utterance such as “I am going to market” using the core word.

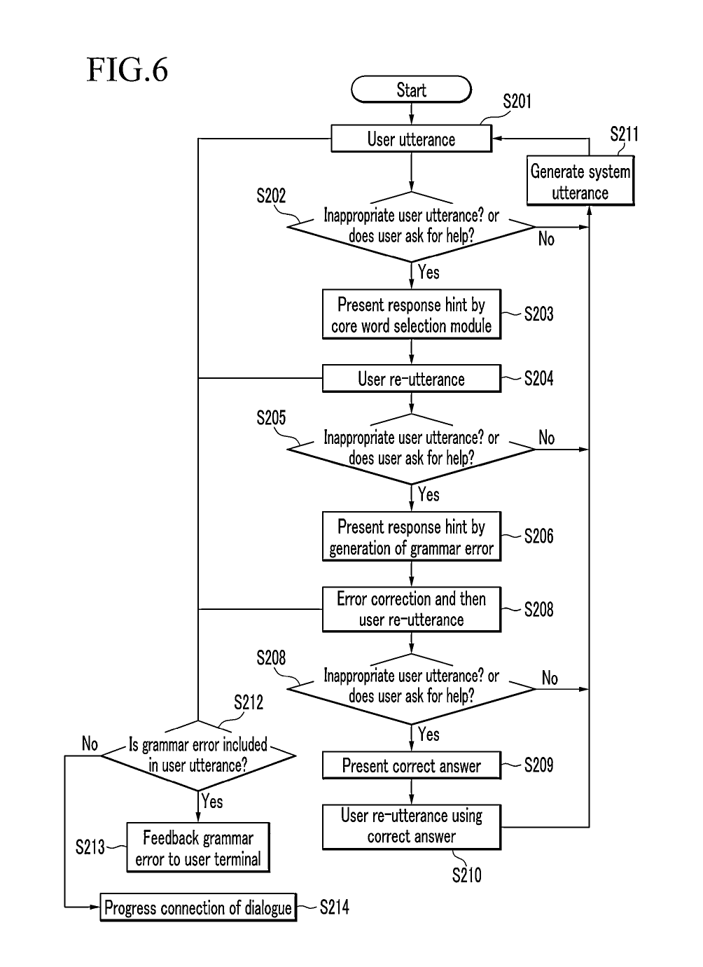

Meanwhile, FIG. 6 is a flowchart illustrating another example of an answer presentation in the language learning method according to the exemplary embodiment of the present invention. The example illustrated in FIG. 4 describes that the process of inducing a correct answer from the response utterance candidates in the language learning method is a selective process, and the example illustrated in of FIG. 6 describes that the processes of inducing a correct answer from the response utterance candidates are performed as a series of processes in time series. The order of the induction type is not limited to the order of FIG. 6, but may be variously changed.

Referring to FIG. 6, the user first uses the user terminal 10 to utter under the given predetermined domain depending on the language learning program (S201). The utterance content of the user is acquired as speech or text data.

Next, it is queried whether the user utterance is an inappropriate utterance or the user asks for help for the dialogue sentence through the user terminal (S202).

When the user utterance is appropriate or the user does not ask for help, the language system generates the response utterance depending on the domain following the user utterance content (S211).

Meanwhile, when the user utterance is inappropriate or the user asks for help, a hint for the appropriate response utterance using the core word is provided (S203)

That is, the core word extractor 600 provides a response hint. The problem presenting method of the response utterance using the core word is as described in FIG. 5.

Next, the user re-utters the sentence using the hint based on the core word presented in step S203 (S204). It is determined whether the re-uttered content is an inappropriate utterance or if the user again asks for help (S205). When the re-uttered content is an appropriate utterance or the user does not ask for help, the process proceeds to S211 to generate a response utterance of a dialogue continued on the system. On the other hand, when the re-uttered content is an inappropriate utterance or the user asks for help, a response hint by a grammar error generation is presented (S206). A method for presenting a response candidate with a grammar error is as described in the steps S8 and S11 of FIG. 4, and the response candidate with the grammar error is presented using the grammar error generator 700.

Then, the user re-utters a sentence without a grammar error by correcting the given grammar error (S207).

In step S207, it is again confirmed whether the sentence re-uttered by the user is an inappropriate utterance or the user asks for help (S208).

When the user utterance is appropriate or the user does not ask for help, the response utterance of the dialogue content continued on the system is generated and transferred to the user (S211). However, when the user utterance is still inappropriate or the user asks for help, a correct answer is presented (S209). Although not illustrated in FIG. 6, prior to presenting a correct answer in step S209, an example choosing problem depending on the corresponding domain as in steps S9 and S12 of FIG. 4 is presented, and the re-utterance step by the user using the presented example choosing problem may be further included.

In step S209, the user performs the re-utterance using the presented correct answer (S210). Then, the language system generates a subsequent continued appropriate utterance response, corresponding to the corresponding user utterance in the corresponding domain (S211).

Meanwhile, referring to the language learning method according to the exemplary embodiment illustrated in FIG. 6, it is confirmed whether the grammar error is included in the user utterance of each step S201, S204, and S207 (S212). When the grammar error is present, the grammar error detected by a grammar error detector 800 is fed back to the user terminal (S213). When the user utterance is performed without the grammar error, the language learning system progresses the following dialogue under the corresponding domain (S214).

The grammar error data transmitted to the user terminal 10 are output through the speech output unit 103 or the text output unit 104 of the user terminal, and the feedback of the grammar error data is directly received every time the user utterance is performed to allow the user to perform the utterance while correcting the grammar error by himself/herself.

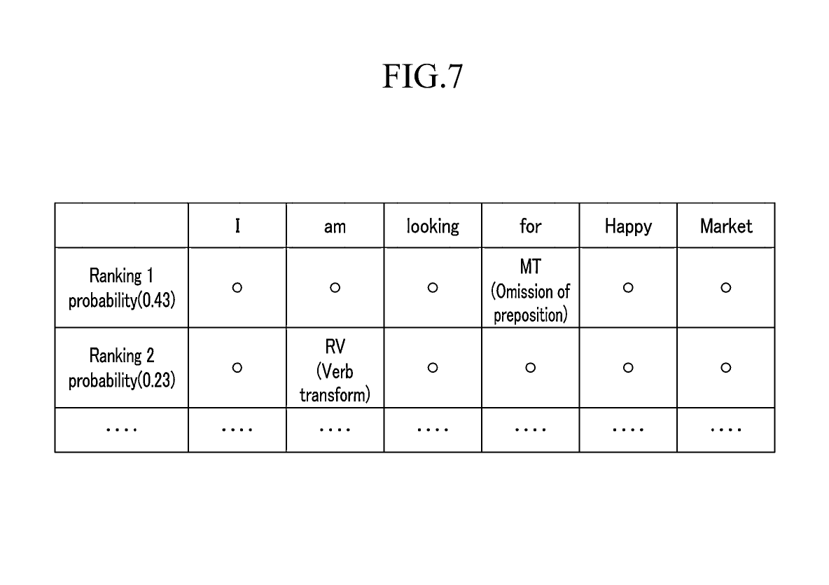

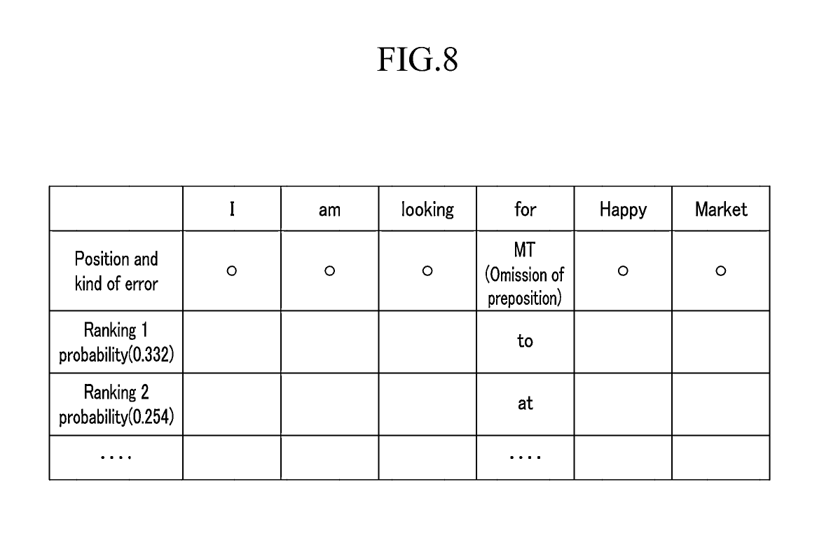

FIGS. 7 and 8 are diagrams illustrating an example of the generation of the grammar error in the language learning system and the language learning method according to the exemplary embodiment of the present invention. In detail, FIGS. 7 and 8 are exemplified diagrams of the case in which the grammar error is generated depending on the exemplary embodiments illustrated in FIGS. 4 and 6 and the grammar quiz presenting the response candidate data with the grammar error to induce the appropriate response utterance of the user is presented.

FIG. 7 is an exemplified diagram in which the position and kind of the grammar error are defined in the sentence, and FIG. 8 is an exemplified diagram in which the actual grammar error sentence is generated by substituting the error, corresponding to the position and kind of the grammar error determined in FIG. 7.

Referring to FIG. 7, one sentence is extracted from a plurality of corpuses in which the response utterances for each domain of the foreign language learner are gathered. When a conditional random field (CRF) is trained by using each word information and morpheme information in the extracted sentence as the feature vector to predict the error probability, the error position, the probability value, and the error kind are output as a prediction result value (n-best result) in the order that the error occurring probability from ranking 1 to ranking n is high. A sample is extracted based on the output probability distribution.

In FIG. 7, when the exemplified sentence extracted from the plurality of corpuses is “I am looking for Happy Market”, the grammar error of ranking 1 is omitted (MT) of the preposition for which is generated at a position of preposition for, and the occurrence probability of the grammar error is predicted to be 0.43. Further, the grammar error of ranking 2 which is the probabilistically subsequent ranking is a transform (RV) of a verb which is generated at a position of the verb am, and the occurrence probability of the grammar error reaches 0.23. Further, the grammar error be arranged up to ranking n at which the probability value of the grammar error occurring in the exemplified sentence is 0.

FIG. 8 illustrates an appearance when the error sentence with the actual grammar error is generated by using the probabilistically determined result value for the position and kind of the grammar error in the exemplified sentence of FIG. 7. Even in the error sentence generation in FIG. 8, the probability value depending on the error may be acquired.

The generation of the sentence with the grammar error may use a Maximum Entropy (ME) machine learning technique, but is not necessarily limited thereto.

When the sentence with the grammar error is generated, as the feature vectors, information of word information, morpheme, lemma, dependency parser, and the like may be used.

When the morpheme information is used as the feature vector, each morpheme of a verb, a noun, an article, and the like for the input sentence is repeatedly trained, and thus the sentence with the grammar error may be extracted. The error words are predicted, selected, and output based on the position and kind of the corresponding error by using the machine learning model after the training. The words and the probability input which may be replaced from ranking 1 to ranking n of the error probability may be output, and the sample is extracted based on the output probability information to generate the error sentence. Otherwise, as another exemplary embodiment, the error words are extracted by a pattern matching technique and are substituted into the sentence.

Referring to FIG. 8, the error sentence for the omission (MT) of the preposition for corresponding to the error of ranking 1 in the sentence of FIG. 7 is generated. The error words (for example, to, at, and the like) corresponding to the position and kind of the error of the corresponding sentence are predicted using the machine learning model, and the error sentence into which the error words are substituted is generated based on the probability information.

For example, the probability of the error sentence into which to is substituted instead of the preposition for corresponds to 0.332 and becomes ranking 1 probability, compared to the case in which other error words are substituted.

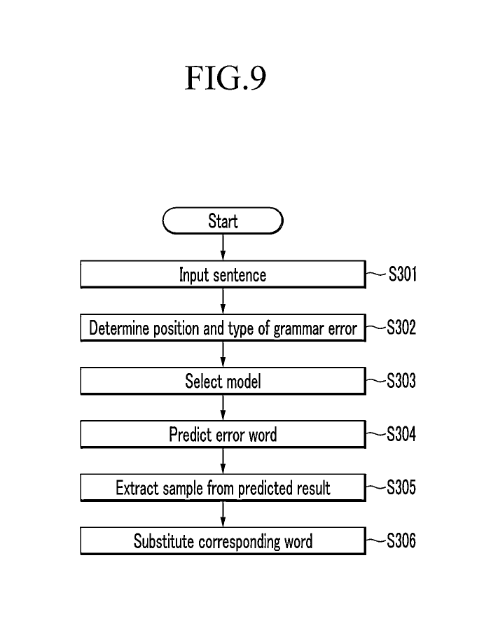

FIG. 9 is a flowchart illustrating a process of generating a grammar error according to the exemplary embodiment of FIGS. 7 and 8 in the language learning method according to the exemplary embodiment of the present invention.

First, one input sentence is selected from the plurality of corpuses gathering the response utterances for each domain of the foreign language learner (S301).

Further, the position of the grammar error and the grammar error type are determined based on the word information or the morpheme information as illustrated in FIG. 7 in the corresponding sentence (S302).

Further, the model of the sentence with the grammar error is extracted and selected by repeatedly training the input sentence based on the morpheme (S303). Further, the probability value may be stored in the generated model of the sentence with the grammar error. The prediction may be performed based on the position and kind of the corresponding error mainly using the machine learning model.

Next, the error words are predicted and generated in the high probability order, corresponding to the error position and type of the input sentence, by using the model selected in step S303 (S304).

Further, the sample is extracted from the predicted result (S305), and the grammar error sentence is generated by substituting the corresponding error word at the error position of the input sentence (S306).

Therefore, the language learning method according to the exemplary embodiment of the present invention of FIG. 9 provides the sentence with the grammar error to the user to induce the appropriate response utterance so as to allow the learner to correct an error by himself/herself, such that the learner participates in learning with interest, thereby improving the learning effect.

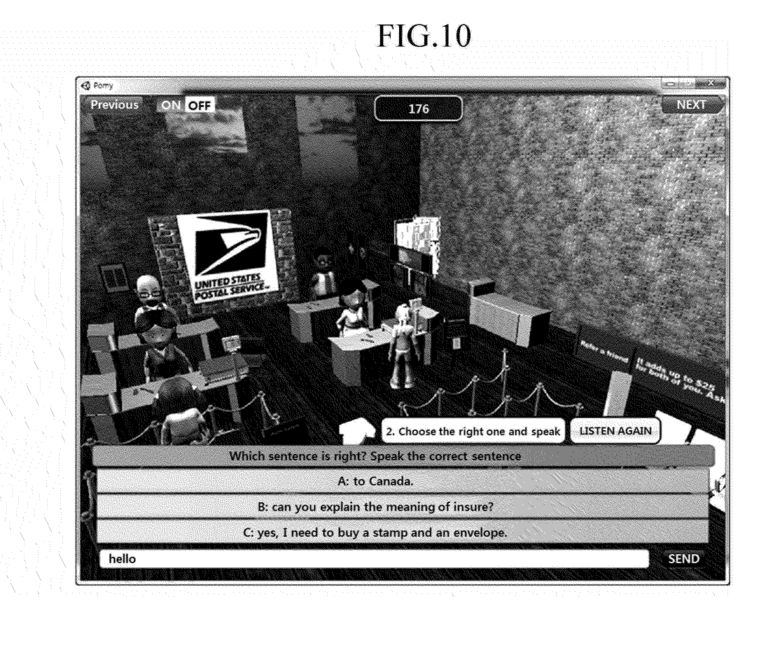

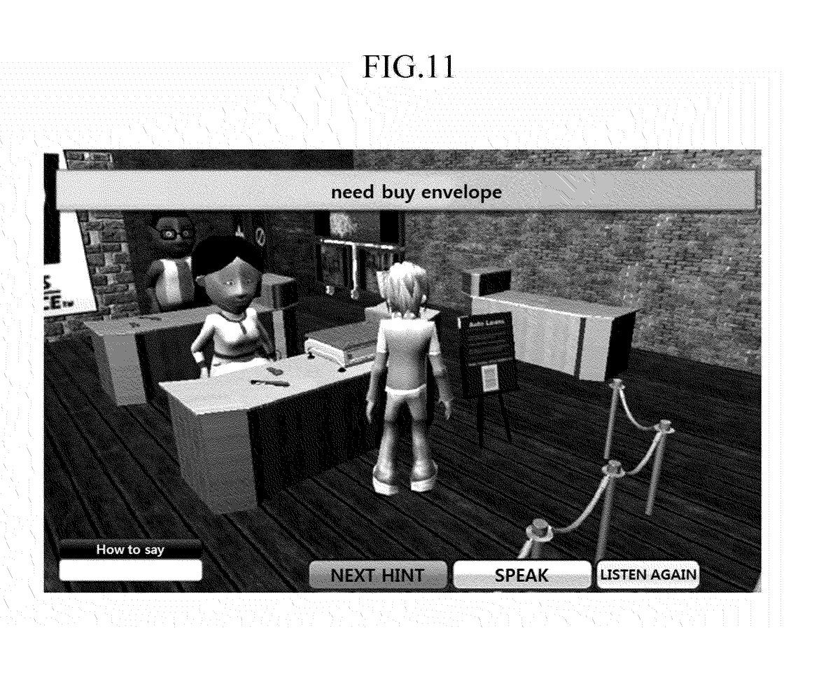

FIG. 10 is a diagram illustrating an exemplified screen of an answer of an example choosing types for uttering a problem and an appropriate response sentence in a given domain according to the language learning system and method according to the exemplary embodiment of the present invention, and FIG. 11 is a diagram illustrating an exemplified screen of inducing the response generationDeletedTextsthrough an extraction of a core word and generation of a grammar error by the above-mentioned process.

For example, FIG. 10 illustrates a screen on which the user utterance is induced under the domain that the user (learner) is a customer of a mail service business.

The main server for language learning presents a predetermined domain such as a dialogue domain of the main service business to the user, and generates a question to induce the dialogue corresponding thereto.

The question content is output as speech or text through the user terminal, and a correct answer may be presented as an example choosing form. Then, the user (learner) selects an appropriate correct answer from the examples of the problem presented as the example choosing form during the progress of the dialogue to perform the utterance.

The question provided from the main server is “May I help you, sir?” under the domain that the user is a customer of the mail service business like the screen illustrated in FIG. 10, and thus an example form of a correct answer may be given like (A) to Canada. (B) Can you explain the meaning of ‘insure’? (C) Yes, I need to buy a stamp and an envelope.

Meanwhile, FIG. 11 illustrates an example of the screen on which, for the appropriate response utterance of the user to the question, the main server for language learning provides the utterance candidate result values for the response generation to the user by various methods. As described above, the utterance candidate result values are data which are provided in the problem type through the extraction of the core words or the problem type through the generation of the grammar error.

When the appropriate response among the plurality of examples transferred to the user to the question of the example illustrated in FIG. 10 is (C) Yes, I need to buy a stamp and an envelope, the core words may be extracted to induce a correct answer and may be presented, or the grammar error may be generated and presented.

As shown on the screen illustrated in FIG. 11, the core word extraction method presents the core words of need buy envelope.

The method for generating a grammar error inserts and presents the grammar error word into the sentence such as (a) Yes (b) I (c) need (d) buying (e) a stamp (f) and envelope, or words in a blank such as Yes, I need a stamp and an envelope (a) buy (b) to buy (c) buying (d) bought are presented by a method for choosing the words to be grammatically corrected.

According to the exemplary embodiment of the present invention, the result values of the utterance candidate generator 500 are coupled with the pre-registered utterance to synthesize speech and provide the synthesized speech to the user.

That is, when the result values selected from the utterance response candidate groups transferred to the user are compressed as “Yes, I need to buy a stamp and an envelope” or “Yes, I want to mail my parcel”, the result values may be provided like “You can say something like ‘Yes, I need to buy a stamp and an envelope’” or “Repeat after me ‘Yes, I want to mail my parcel?’” by being coupled with “You can say something like” or “Repeat after me”, and the like which is the pre-registered sentence as the usage provided to the user.

In summary, the language learning system according to the exemplary embodiment of the present invention includes: a user terminal receiving utterance information of a user as a speech or text type and outputting learning data transferred through a network to the user as the speech or text type; and a main server configured to include a learning processing unit analyzing a meaning of the utterance information of the user and generating at least one response utterance candidate corresponding to dialogue learning in a predetermined domain to induce a correct answer of the user and connecting dialogue depending on the domain and a storage unit linked with the learning processing unit to store material data or a dialogue model depending on the dialogue learning.

The learning processing unit includes: a semantic analyzer recognizing a meaning of the sentence of the utterance information of the user using an analysis model; a dialogue manager determining whether a content depending on the utterance information of the user is an utterance content corresponding to the domain and generating a connection utterance presenting or following a correct answer depending on the dialogue learning; an utterance candidate generator generating at least one response utterance candidate corresponding to the dialogue learning depending on the domain; a speech synthesis unit synthesizing speech by coupling a result value of the response utterance candidate generated by the utterance candidate generator with the pre-registered utterance information and outputting the synthesized speech to a user terminal; and a response inducer generating and providing a core word or a grammar error sentence to the user terminal by using the response utterance candidate generated by the utterance candidate generator to induce the user response utterance corresponding to the domain.

The learning processing unit may further include a speech recognizer changing the speech to text data when the utterance information of the user is the speech.

The response inducer includes: a core word extractor extracting the core word to the user terminal using a response utterance candidate generated by the utterance candidate generator and presenting the core word to the user terminal; a grammar error generator modeling grammar error generation using the response utterance candidate generated by the utterance candidate generator and generating a sentence or an example problem with the grammar error and presenting the generated sentence or example problem to the user terminal; and a grammar error detector detecting a grammar error for a response corrected and uttered by the user using the core word extractor and the grammar error detector.

The core word extractor sequentially extracts words which are tagged in a minimum semantic unit from an input sentence selected from the response utterance candidate data to change a non-registered word corresponding to a noun or a verb to a basic form so as to be stored as a core word.

The grammar error generator extracts a model of a grammar error sentence based on a minimum semantic unit of the input sentence selected from the response utterance candidate data, predicts and generates an error word based on a probability value of a position and a kind of the grammar error, and generates the example problem including a sentence substituted into the error word or the error word.

The utterance candidate generator may include: a dialogue order extractor extracting at least one dialogue example associated with the predetermined domain from the sentence information stored in the storage unit; a node weight calculator calculating a sentence included in a current dialogue for the domain and a relative value of weight of each sentence included in the at least one dialogue example; a dialogue similarity calculator calculating similarity between sentences using the relative value of weight of the sentence included in the current dialogue and the sentence included in the dialogue example, respectively, and aligning an order of the dialogue example depending on a result value of the similarity; a relative position calculator calculating a relative position between the sentences based on the order of the dialogue example information stored in the storage unit; an entity name agreement calculator calculating a probability value that a unique mark of the sentence included in the current dialogue agrees with unique marks of each sentence; and an utterance aligner aligning the sentence of the dialogue example based on results of the dialogue similarity calculator, the relative position calculator, and the entity name agreement calculator, and determining the at least one response utterance candidate depending on a predetermined ranking.

The sentence included in the current dialogue and the sentence included in the dialogue example may each be tagged in a form of a dialogue subject, a sentence format, a subject element of a sentence, and a proper noun element depending on a semantic analysis model, but is not limited to the exemplary embodiment.

The storage unit includes: a semantic analysis model storing result analysis values of a sentence depending on the semantic analysis model; a dialogue example database storing a plurality of dialogue examples configured of a series of dialogue sentences associated with the predetermined domain among dialogue corpus data; a dialogue example calculation model storing a calculation module designating a response candidate of the user for the domain and storing the response utterance candidate selected depending on the calculation module; a grammar error generation model modeling a grammar error for a predetermined response sentence among the response utterance candidates and storing a grammar error response candidate sentence with the grammar error word selected depending on the probability value; and a grammar error detection model storing grammar error result data detecting grammar errors for the utterance information of the user and the utterance information corrected and answered by the user.

A language learning method according to an exemplary embodiment of the present invention includes: accessing a main server for language learning to input utterance information for dialogue learning under a predetermined domain; analyzing a meaning of the utterance information of a user and determining whether the analyzed utterance information is an utterance content corresponding to the domain to manage the dialogue learning; and progressing following dialogue learning in the domain in the case of the utterance corresponding to the domain; and generating at least one response utterance candidate data corresponding to the dialogue learning under the domain in the case of the utterance which does not correspond to the domain or when there is a request of the user and inducing a response utterance of the user corresponding to the domain.

The at least one response utterance candidate data may be aligned corresponding to a probability ranking depending on appropriateness and a weight for the domain.

The at least one response utterance candidate data may be coupled with pre-registered utterance information data to be output as speech synthesis data from a user terminal.

The inducing of the response utterance of the user includes at least one of: a first step of presenting an example choosing problem for the response utterance corresponding to the domain; a second step of extracting and presenting core words using the at least one response utterance candidate data; and a third step of modeling generation of a grammar error using the at least one response utterance candidate data, and generating and presenting a sentence with the grammar error or an example problem with the grammar error and a correct answer.

The second step may include: selecting an input sentence from the at least one response utterance candidate data and tagging the selected input sentence in a minimum semantic unit; sequentially extracting words from the beginning of the input sentence; confirming whether the extracted word corresponds to a noun or a verb; confirming whether the extracted word is a pre-registered core word; changing, registering, and storing the extracted word as a basic type when the extracted word corresponds to a noun or a verb and is not registered; and presenting the registered and stored core words and inducing the response utterance corresponding to the domain.

The third step may include: selecting an input sentence from the at least one response utterance candidate data and extracting a model of a sentence with a grammar error based on a minimum semantic unit; predicting an error word based on a probability value of a position and a kind of the grammar error by modeling the sentence with the grammar error; and inferring a response utterance corresponding to the domain by presenting an example problem including a sentence substituted into the error word or including the error word.

The generating of the at least one response utterance candidate data may include: extracting at least one dialogue example associated with the domain from sentence information; calculating a sentence included in a current dialogue for the domain and a relative value of weight of each sentence included in the at least one dialogue example; calculating similarity between sentences using the relative value of weight of the sentence included in the current dialogue and the sentence included in the dialogue example, respectively, and aligning an order of the dialogue example depending on a result value of the similarity; calculating a relative position between sentences included in the current dialogue and the sentence included in the dialogue example, respectively, based on an order of the dialogue example information; calculating a probability value that a unique mark of the sentence included in the current dialogue agrees with unique marks of each sentence; and aligning a sentence of a dialogue example based on the similarity, the relative position, and the result of the probability value, and determining the sentence of the dialogue example as the at least one response utterance candidate data.

A language learning method according to another exemplary embodiment of the present invention includes: accessing a main server for language learning to input utterance information for dialogue learning under a predetermined domain; analyzing a meaning of user utterance information and determining whether the analyzed utterance information is utterance content corresponding to the domain; progressing following dialogue learning in the domain in the case of a correct answer utterance corresponding to the domain; generating at least one response utterance candidate data to extract core words in the case of the utterance which does not correspond to the domain or when there is a request of the user, and providing a first hint for a response utterance corresponding to the domain; inputting, by the user, first re-utterance information using the first hint and modeling a generation of a grammar error using the at least one response utterance candidate data when the first re-utterance information is an utterance which does not correspond to the domain or there is the request of the user to provide a second hint due to the acquired grammar error; and inputting, by the user, second re-utterance information using the second hint and directly providing a correct answer utterance corresponding to the domain when the second re-utterance information is an utterance which does not correspond to the domain or there is the request of the user.

The language learning method may further include, prior to the directly providing of the correct answer utterance, providing a third hint in a plurality of example choosing forms including the correct answer utterance data to the user.

The language learning method may further include detecting the grammar error for the utterance information, the first re-utterance information, and the second re-utterance information for the dialogue learning under the predetermined domain, and feeding back the detected grammar error to a user terminal.

The accompanying drawings and the detailed description of the present invention which are referred until now are only an example of the present invention, and are used to describe the present invention but are not used to limit the meaning or the scope of the present invention described in the appended claims. Therefore, those skilled in the art may easily perform selection and replacement therefrom. Further, those skilled in the art may omit components without reducing performance of some of the components described in the present specification or add components to improve performance. In addition, those skilled in the art may change an order of steps of a method described in the present specification depending on process environment or equipment. Therefore, the scope of the present invention is to be defined by the accompanying claims and their equivalences rather than the embodiments described above.

It is possible to provide a foreign language education system and a foreign language education method developed online to expect a learning effect comparable with an actual education level given by a native speaker or a foreign language teacher offline, by providing a learning system and a learning method for generating a most appropriate response using natural language processing during language learning.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A language learning system, comprising:
a user terminal configured to receive utterance information of a user as a speech or text type and to outputlearning data transferred through a network to the user as the speech or text type; and
a main server includes:
a learning processing unit configured to analyze a meaning of the utterance information of the user, to generate at least one response utterance candidate corresponding to dialogue learning in a predetermined domain to induce a correct answer of the user, and to connect a dialogue depending on the domain; and
a storage unit linked with the learning processing unit and configured to store material data or a dialogue model depending on the dialogue learning.

2. The language learning system of claim 1, wherein
the learning processing unit includes:
a semantic analyzer configured to recognize a meaning of a sentence of the utterance information of the user using an analysis model;
a dialogue manager configured to determine whether content depending on the utterance information of the user is utterance content corresponding to the domain and to generate a connection utterance presenting or following a correct answer depending on the dialogue learning;
an utterance candidate generator configured to generate at least one response utterance candidate corresponding to the dialogue learning depending on the domain;
a speech synthesis unit configured to synthesize speech by coupling a result value of the response utterance candidate generated by the utterance candidate generator with the pre-registered utterance information and to output the synthesized speech to a user terminal; and
a response inducer configured to generate a core word or a grammar error sentence by using the response utterance candidate generated by the utterance candidate generator to induce the user response utterance corresponding to the domain and to provide the core word or the grammar error sentence to the user terminal.

3. The language learning system of claim 2, wherein
the learning processing unit
further includes a speech recognizer configured to change the speech to text data when the utterance information of the user is the speech.

4. The language learning system of claim 2, wherein
the response inducer includes:
a core word extractor configured to extracte a core word to the user terminal using a response utterance candidate generated by the utterance candidate generator and to present the core word to the user terminal;
a grammar error generator configured to model grammar error generation using the response utterance candidate generated by the utterance candidate generator, to generate a sentence or an example problem with the grammar error and to present the generated sentence or example problem to the user terminal; and
a grammar error detector configured to detecting a grammar error for a response corrected and uttered by the user using the core word extractor and the grammar error detector.

5. The language learning system of claim 4, wherein
the core word extractor configured to tag an input sentence selected from the response utterance candidate data in a minimum semantic unit, to sequentially extract words from the input sentence, to change a non-registered word of the extracted words corresponding to a noun or a verb to a basic form and to store the non-registered word as a core word.

6. The language learning system of claim 4, wherein
the grammar error generator configured to extract a model of a grammar error sentence based on a minimum semantic unit of the input sentence selected from the response utterance candidate data, to predict and to generate an error word based on a probability value of a position and a kind of the grammar error, and to generate the example problem including a sentence substituted into the error word or the error word.

7. The language learning system of claim 2, wherein
the utterance candidate generator includes:
a dialogue order extractor configured to extract at least one dialogue example associated with the predetermined domain from the sentence information stored in the storage unit;
a node weight calculator configured to calculate a sentence included in a current dialogue for the domain and a relative value of weight of each sentence included in the at least one dialogue example;
a dialogue similarity calculator configured to calculate similarity between sentences using the relative value of weight of the sentence included in the current dialogue and the sentence included in the dialogue example, respectively, and to align an order of the dialogue example depending on a result value of the similarity;
a relative position calculator configured to calculate a relative position between the sentences included in the current dialogue and the sentence included in the dialogue example, respectively, based on the order of the dialogue example information stored in the storage unit;
an entity name agreement calculator configured to calculate a probability value that a unique mark of the sentence included in the current dialogue agrees with unique marks of each sentence; and
an utterance aligner configured to align the sentence of the dialogue example based on results of the dialogue similarity calculator, the relative position calculator, and the entity name agreement calculator and to determine the at least one response utterance candidate depending on a predetermined ranking.

8. The language learning system of claim 7, wherein
the sentence included in the current dialogue and the sentence included in the dialogue example are each tagged in a form of a dialogue subject, a sentence format, a subject element of a sentence, and a proper noun element depending on a semantic analysis model.

9. The language learning system of claim 1, wherein
the storage unit includes:
a semantic analysis model unit configured to store result analysis values of a sentence analized by using a semantic analysis model;
a dialogue example database configured to store a plurality of dialogue examples configured of a series of dialogue sentences related to a predetermined domain among dialogue corpus data;
a dialogue example calculation model configured to store a calculation model designating a response candidate of the user for the domain and the response utterance candidate selected by using the calculation model;
a grammar error generation model configured to model a grammar error for a predetermined response sentence among the response utterance candidates and to store a grammar error response candidate sentence with the grammar error word selected depending on the probability value; and
a grammar error detection model configured to store grammar error result data detecting grammar errors for the utterance information of the user and the utterance information corrected and answered by the user.

10. A language learning method, comprising:
accessing a main server for language learning to input utterance information for dialogue learning under a predetermined domain;
analyzing a meaning of the utterance information of a user and determining whether the utterance information is utterance content corresponding to the domain for managing the dialogue learning;
progressing following dialogue learning in the domain in the case of the utterance corresponding to the domain; and
generating at least one response utterance candidate data corresponding to the dialogue learning under the domain in the case of the utterance which does not correspond to the domain or when there is a request of the user and inducing a response utterance of the user corresponding to the domain.

11. The language learning method of claim 10, wherein
the at least one response utterance candidate data is aligned corresponding to a probability ranking depending on appropriateness and a weight for the domain.

12. The language learning method of claim 10, wherein
the at least one response utterance candidate data is coupled with pre-registered utterance information data to be output as speech synthesis data from a user terminal.

13. The language learning method of claim 10, wherein
the inducing of the response utterance of the user includes at least one of:
a first step of presenting an example choosing problem for the response utterance corresponding to the domain;
a second step of extracting and presenting core words using the at least one response utterance candidate data; and
a third step of modeling generation of a grammar error using the at least one response utterance candidate data and generating and presenting a sentence with the grammar error or an example problem with the grammar error and a correct answer.

14. The language learning method of claim 13, wherein
the second step includes:
selecting an input sentence from the at least one response utterance candidate data and tagging the selected input sentence in a minimum semantic unit;
sequentially extracting words from the beginning of the input sentence;
confirming whether the extracted word corresponds to a noun or a verb;
confirming whether the extracted word is a pre-registered core word;
changing, registering, and storing the extracted word as a basic type when the extracted word corresponds to a noun or a verb and is not registered; and
presenting the registered and stored core words and inferring the response utterance corresponding to the domain.

15. The language learning method of claim 13, wherein
the third step includes:
selecting an input sentence from the at least one response utterance candidate data and extracting a model of a sentence with a grammar error based on a minimum semantic unit;
predicting an error word based on a probability value of a position and a kind of the grammar error by modeling the sentence with the grammar error; and
inducing a response utterance corresponding to the domain by presenting an example problem including a sentence substituted into the error word or including the error word.

16. The language learning method of claim 10, wherein
the generating of the at least one response utterance candidate data includes:
extracting at least one dialogue example associated with the domain from sentence information;
calculating a sentence included in a current dialogue for the domain and a relative value of weight of each sentence included in the at least one dialogue example;
calculating similarity between sentences using the relative value of weight of the sentence included in the current dialogue and the sentence included in the dialogue example, respectively, and aligning an order of the dialogue example depending on a result value of the similarity;
calculating a relative position between sentences included in the current dialogue and the sentence included in the dialogue example, respectively, based on an order of the dialogue example information;
calculating a probability value that a unique mark of the sentence included in the current dialogue agrees with unique marks of each sentence; and
aligning a sentence of a dialogue example based on the similarity, the relative position, and the result of the probability value, and determining the sentence of the dialogue example as the at least one response utterance candidate data.

17. A language learning method, comprising:
accessing a main server for language learning to input utterance information for dialogue learning under a predetermined domain;
analyzing a meaning of user utterance information and determining whether the analyzed utterance information is utterance content corresponding to the domain;
progressing following dialogue learning in the domain in the case of a correct answer utterance corresponding to the domain;
generating at least one response utterance candidate data to extract core words in the case of the utterance which does not correspond to the domain or when there is a request of the user and providing a first hint for a response utterance corresponding to the domain;
inputting, by the user, first re-utterance information using the first hint and modeling generation of a grammar error using the at least one response utterance candidate data when the first re-utterance information is an utterance which does not correspond to the domain or there is the request of the user to provide a second hint due to the acquired grammar error; and
inputting, by the user, second re-utterance information using the second hint and directly providing a correct answer utterance corresponding to the domain when the second re-utterance information is an utterance which does not correspond to the domain or there is the request of the user.

18. The language learning method of claim 17, further comprising,
prior to the directly providing of the correct answer utterance, providing a third hint in a plurality of example choosing forms including the correct answer utterance data to the user.

19. The language learning method of claim 17, further comprising
detecting the grammar error for the utterance information, the first re-utterance information, and the second re-utterance information for the dialogue learning under the predetermined domain, and feeding back the detected grammar error to a user terminal.

20. The language learning method of claim 17, wherein
the at least one response utterance candidate data is coupled with pre-registered utterance information data to be output as speech synthesis data from a user terminal.
